(19) United States
(12) Patent Application Publication
(10) Pub. No.: US 2014/0326357 A1
(43) Pub. Date: Nov. 6, 2014

(54) METHODS OF PRODUCING FLEXIBLE PIPE BODIES, AND FLEXIBLE PIPE BODIES

(71) Applicant: Wellstream International Limited, Newcastle-upon-Tyne, Tyne and Wear (GB)

(72) Inventor: Geoffrey Stephen Graham, Newcastle-upon-Tyne (GB)

(73) Assignee: Wellstream International Limited, Newcastle-upon-Tyne, Tyne and Wear (GB)

(21) Appl. No.: 14/365,958

(22) PCT Filed: Oct. 15, 2012
(86) PCT No.: PCT/GB2012/052552

§ 371 Date: Jun. 16, 2014

(30) Foreign Application Priority Data
Dec. 20, 2011 (GB) 1121876.5

(51) Int. Cl. F16L 11/04; B29D 23/00

(52) U.S. Cl. CPC F16L 11/04; B29D 23/001
USPC 138/137; 156/187

(57) ABSTRACT

A flexible pipe body and method of producing a flexible pipe body are disclosed. The method includes providing a length of composite material of thermoplastic or thermosetting material with an electrically conductive material dispersed therein, applying the length to a mandrel or a layer of flexible pipe body, and heating the length by induction heating using an induction heating coil to cure the thermoplastic or thermosetting material.

The present invention relates to a flexible pipe body and a method of producing a flexible pipe body. In particular, but not exclusively, the present invention relates to the use of composites including thermoplastic or thermosetting material and electrically conductive material for forming one or more layer of pipe body.

Traditionally flexible pipe is utilised to transport production fluids, such as oil and/or gas and/or water, from one location to another. Flexible pipe is particularly useful in connecting a sub-sea location (which may be deep underwater, say 1000 metres or more) to a sea level location. The pipe may have an internal diameter of typically up to around 0.6 metres. Flexible pipe is generally formed as an assembly of a flexible pipe body and one or more end fittings. The pipe body is typically formed as a combination of layered materials that form a pressure-containing conduit. The pipe structure allows large deflections without causing bending stresses that impair the pipe's functionality over its lifetime. The pipe body is generally built up as a combined structure including metallic and polymer layers.

Unbonded flexible pipe has been used for deep water (less than 3,300 feet (1,005.84 metres)) and ultra deep water (greater than 3,300 feet) developments. It is the increasing demand for oil which is causing exploration to occur at greater and greater depths where environmental factors are more extreme. For example in such deep and ultra-deep water environments ocean floor temperature increases the risk of production fluids cooling to a temperature that may lead to pipe blockage. Increased depths also increase the pressure associated with the environment in which the flexible pipe must operate. As a result the need for high levels of performance from the layers of the flexible pipe body is increased.

Flexible pipe may also be used for shallow water applications (for example less than around 500 metres depth) or even for shore (overland) applications.

In flexible pipes there are often used polymer layers, such as PVDF (polyvinylidene fluoride). However, most polymers will have a certain maximum allowable strain above which the risk of damage to the material is much greater. Flexible pipe layers are often formed having residual stresses within a polymer layer or layers. PVDF often suffers from high residual stress caused by thermal shock after an extruded layer has been cooled. Extrusion may also cause crazing problems in PVDF when extruded to high temperatures (for example around 215° C.).

One technique which has been used in the past to in some way alleviate problems of stresses and strain decreasing strength is the use of fibre-reinforced polymeric material (or composites) as structural elements in flexible pipes. Composites provide a high specific strength and stiffness and can enable reduced pipe weight (reducing top tension), and increase chemical resistance of the pipe compared to known metallic materials. The composite may be initially provided as a “pre-preg”, i.e. pre-impregnated with fibres.

However, when the formed tape is wound to create a layer of a tubular pipe body, strain is introduced into the material, which affects performance.

US2003/0026928 discloses a flexible pipe including composite tapes of fibres and thermoset resin. The tape is formed of thin, superimposed laminates bonded together by an adhesive. Using thin laminates helps to reduce strain when the layer is bent onto a pipe body surface. However, strain is not completely eliminated, and also the layer thickness, adhesive coverage and application timing must be carefully controlled. Also, in use, a layer of bonded laminates would be susceptible to inter-laminate shear as interfaces interact during movement of the pipe or twisting of the layer.

Furthermore, when preparing composite tape layers, the tape may be heated using infrared radiation, for example. This technique however may cause damage to the outside portions of the pipe layer whilst the inner portion of the pipe layer is not heated enough.

It is an aim of the present invention to at least partly mitigate the above-mentioned problems.

It is an aim of embodiments of the present invention to provide layers in a flexible pipe body, of composite material that gives strength and stiffness to a pipe, whilst also giving sufficient flexibility to the pipe as it bends.

It is an aim of embodiments of the present invention to provide armour layers in a flexible pipe body of composite material that are substantially free of residual strain.

It is an aim of embodiments of the present invention to provide a method of forming a polymer layer that is more controllable than known methods.

It is an aim of embodiments of the invention to provide a method of heating a polymer layer that enables a more even heating than known methods.

According to a first aspect of the present invention there is provided a method of producing a flexible pipe body, comprising:
providing a length of composite material of thermoplastic or thermosetting material with an electrically conductive material dispersed therein;
applying the length to a mandrel or a layer of flexible pipe body; and
heating the length by induction heating to cure the thermoplastic or thermosetting material.

According to a second aspect of the present invention there is provided a flexible pipe body, comprising:
a layer of composite material of thermoplastic or thermosetting material with an electrically conductive material dispersed therein,
wherein the layer is formed by applying the composite material to a mandrel or a further layer of flexible pipe body and heating the composite material by induction heating to cure the thermoplastic or thermosetting material.

Certain embodiments of the invention provide the advantage that residual stress in the formed pipe body layer is reduced or eliminated. This leads to a higher performance in terms of strength and lifetime, improved spoolability and improved flexibility, for example.

Certain embodiments of the invention provide the advantage that a method of forming a flexible pipe body is provided that offers a high degree of control over the heating of polymer material, whether the material is heated from the inside outwards, or only the outside is heated.

Certain embodiments of the invention may be easily incorporated into existing pipe forming apparatus. Certain embodiments of the invention provide improvements in terms of cost efficiency and ease of use.

Embodiments of the invention are further described hereinafter with reference to the accompanying drawings, in which:

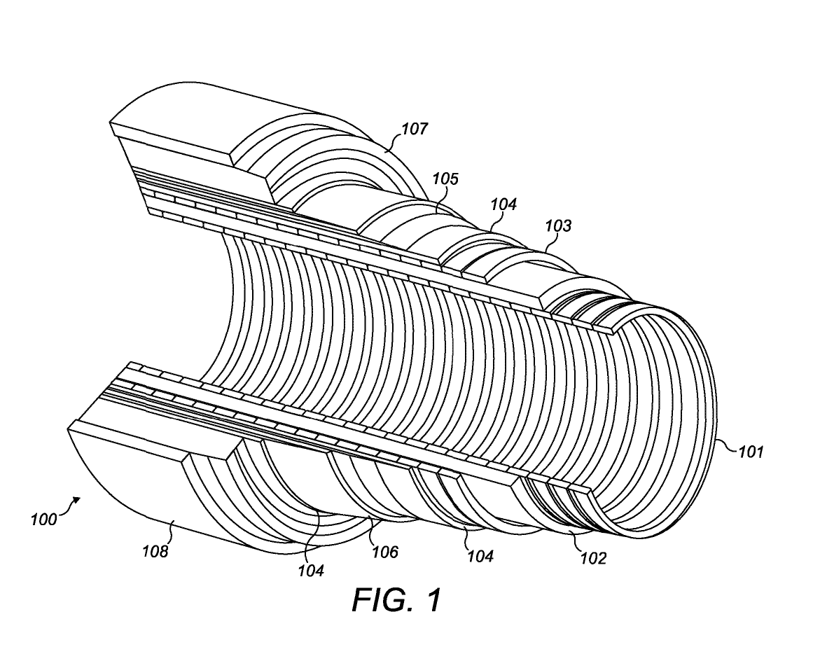

FIG. 1 illustrates a flexible pipe body;

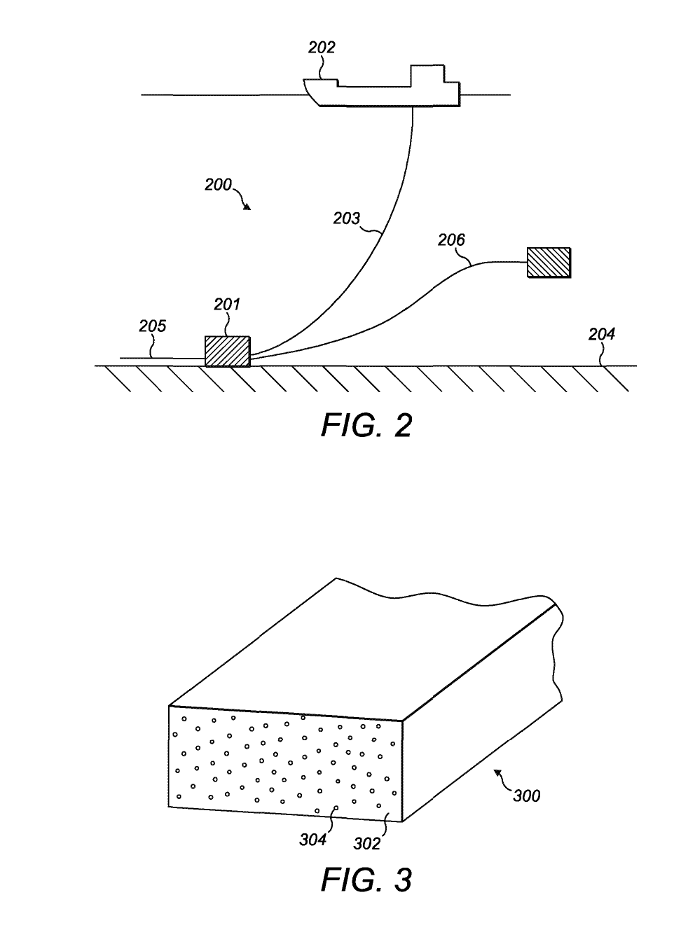

FIG. 2 illustrates a riser assembly;

FIG. 3 illustrates a tape element of the present invention;

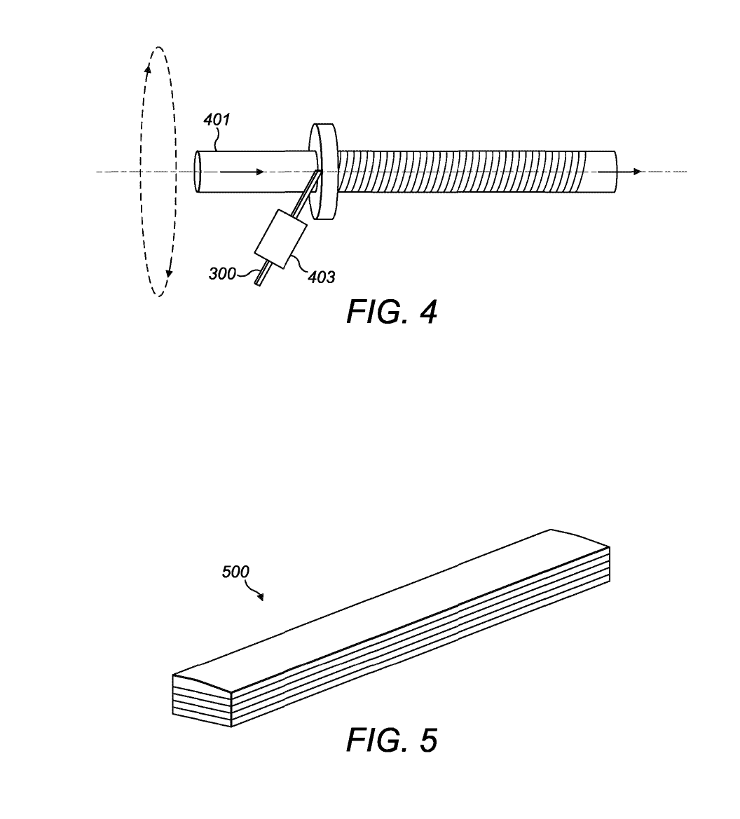

FIG. 4 illustrates a pipe layer forming apparatus;

FIG. 5 illustrates another tape of the present invention;

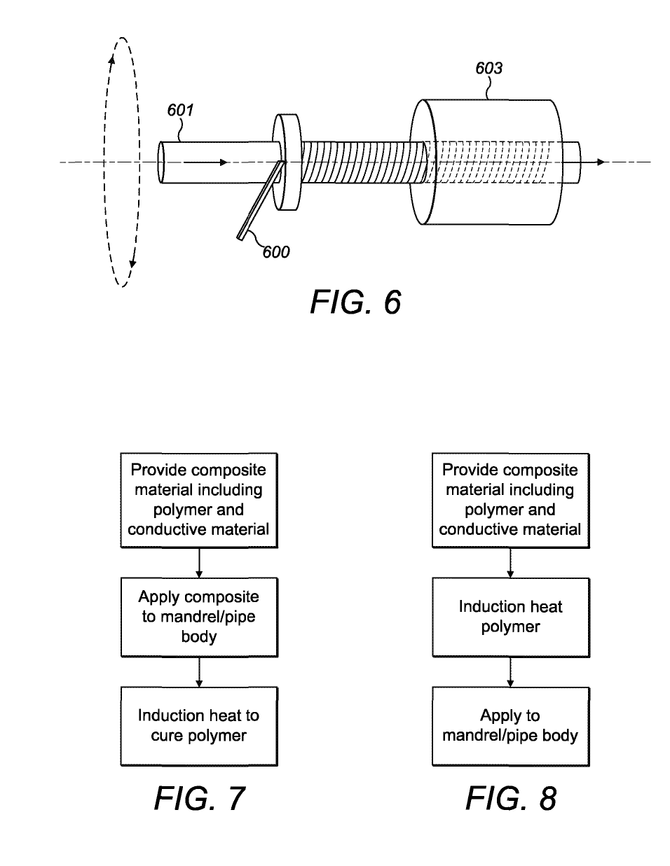

FIG. 6 illustrates another pipe layer forming apparatus;

FIG. 7 is a flow diagram of a method of the present invention; and

FIG. 8 is another flow diagram of a method of the present invention.

In the drawings like reference numerals refer to like parts.

Throughout this description, reference will be made to a flexible pipe. It will be understood that a flexible pipe is an assembly of a portion of a pipe body and one or more end fittings in each of which a respective end of the pipe body is terminated. FIG. 1 illustrates how pipe body 100 is formed in accordance with an embodiment of the present invention from a combination of layered materials that form a pressure-containing conduit. Although a number of particular layers are illustrated in FIG. 1, it is to be understood that the present invention is broadly applicable to coaxial pipe body structures including two or more layers manufactured from a variety of possible materials. It is to be further noted that the layer thicknesses are shown for illustrative purposes only.

As illustrated in FIG. 1, a pipe body includes an optional innermost carcass layer 101. The carcass provides an interlocked construction that can be used as the innermost layer to prevent, totally or partially, collapse of an internal pressure sheath 102 due to pipe decompression, external pressure, and tensile armour pressure and mechanical crushing loads. It will be appreciated that certain embodiments of the present invention are applicable to ‘smooth bore’ operations (i.e. without a carcass) as well as such ‘rough bore’ applications (with a carcass).

The internal pressure sheath 102 acts as a fluid retaining layer and comprises a polymer layer that ensures internal fluid integrity. It is to be understood that this layer may itself comprise a number of sub-layers. It will be appreciated that when the optional carcass layer is utilised the internal pressure sheath is often referred to by those skilled in the art as a barrier layer. In operation without such a carcass (so-called smooth bore operation) the internal pressure sheath may be referred to as a liner.

An optional pressure armour layer 103 is a structural layer with a lay angle close to 90° that increases the resistance of the flexible pipe to internal and external pressure and mechanical crushing loads. The layer also structurally supports the internal pressure sheath, and typically consists of an interlocked construction.

The flexible pipe body also includes an optional first tensile armour layer 105 and optional second tensile armour layer 106. Each tensile armour layer is a structural layer with a lay angle typically between 10° and 55°. Each layer is used to sustain tensile loads and internal pressure. The tensile armour layers are often counter-wound in pairs.

The flexible pipe body shown also includes optional layers of tape 104 which help contain underlying layers and to some extent prevent abrasion between adjacent layers.

The flexible pipe body also typically includes optional layers of insulation 107 and an outer sheath 108, which comprises a polymer layer used to protect the pipe against penetration of seawater and other external environments, corrosion, abrasion and mechanical damage.

Each flexible pipe comprises at least one portion, sometimes referred to as a segment or section of pipe body 100 together with an end fitting located at at least one end of the flexible pipe. An end fitting provides a mechanical device which forms the transition between the flexible pipe body and a connector. The different pipe layers as shown, for example, in FIG. 1 are terminated in the end fitting in such a way as to transfer the load between the flexible pipe and the connector.

FIG. 2 illustrates a riser assembly 200 suitable for transporting production fluid such as oil and/or gas and/or water from a sub-sea location 201 to a floating facility 202. For example, in FIG. 2 the sub-sea location 201 includes a sub-sea flow line. The flexible flow line 205 comprises a flexible pipe, wholly or in part, resting on the sea floor 204 or buried below the sea floor and used in a static application. The floating facility may be provided by a platform and/or buoy or, as illustrated in FIG. 2, a ship. The riser assembly 200 is provided as a flexible riser, that is to say a flexible pipe 203 connecting the ship to the sea floor installation. The flexible pipe may be in segments of flexible pipe body with connecting end fittings.

It will be appreciated that there are different types of riser, as is well-known by those skilled in the art. Embodiments of the present invention may be used with any type of riser, such as a freely suspended (free, catenary riser), a riser restrained to some extent (buoys, chains), totally restrained riser or enclosed in a tube (I or J tubes).

FIG. 2 also illustrates how portions of flexible pipe can be utilised as a flow line 205 or jumper 206.

As shown in FIG. 3, a length of tape 300 is provided for forming a pipe body layer according to a first embodiment of the present invention. The tape 300 is of a composite material of a thermoplastic 302 (in this case PVDF) having carbon fibres 304 dispersed therethrough. The carbon fibres 304 are provided in sufficient quantity to be able to provide heat by induction from an induction heating coil in proximity to the manufacturing point, and can be determined by one skilled in the art. As such, any suitable ferromagnetic material could be used for this purpose.

As shown in FIG. 4, the tape 300 is applied to a mandrel 401 that rotates at a constant speed to receive the tape at even spacing. The tape may overlap somewhat so as to form a tubular shaped member. Just prior to being received on the mandrel 401, the tape 300 passes through or adjacent an induction heating coil 403. The heating coil 403 passes an alternating current and creates a magnetic field. Electrical energy is transferred to the carbon fibres 304, which then produce heat. This leads to the thermoplastic material 302 receiving localised heat directly from the fibres that run through it, the heat sufficient to cure the thermoplastic resin 302. As such, the tape 300 may consolidate into a unitary piece of tube. The mandrel can be removed after an appropriate cooling time to leave a consolidated layer of flexible pipe body. In this example the consolidated layer forms an innermost (smoothbore) liner of a pipe body. Alternatively further layers of pipe body may be added to the formed layer before the mandrel is removed.

Since the carbon fibres are dispersed within the composite matrix, heating can occur evenly throughout the tape. The induction heating coil can be precisely tuned to provide the specific amount of induction heating for the particular materials and application requirements. The fraction of carbon fibres may be any suitable amount such as between around 40% to around 75%. The carbon fibres may be orientated in a particular direction to help give improved strength characteristic to the material in that direction.

Since the heating occurs shortly prior to the tape being helically wound, the tape will remain in a formable shape whilst the winding occurs. As such, strain within the layer will be decreased or even eliminated, since the material is not bent or reformed into new positions after the curing stage.

The carbon fibres not only help to reinforce the composite material structurally, improving strength and weight properties, but also acts as a ferromagnetic material in which an electric field can be induced by an induction heating coil in the vicinity.

In a variation to the embodiment described above, a stack of thin tapes could be stacked as shown in FIG. 5 to create a tape 500 similar to the tape 300, ready for winding. The precursor lengths are stacked broad side to broad side in a laminate fashion. The spooling of the tape and curing of the resin then takes place in the same manner as described above.

By forming the layer from a stack of relatively thinner tapes, the initial alignment of carbon fibres can be more carefully controlled and thus more uniformly orientated. Also, the precursor material is less likely to become damaged during bending and spooling before the curing stage.

A further embodiment of the invention is illustrated in FIG. 6. A tape 600 is applied to a mandrel 601 that rotates at a constant speed to receive the tape at even spacing. The tape 600 may be the same as described with respect to FIG. 3, or another polymer thermoplastic or thermosetting material with conductive elements dispersed therein. The tape may overlap somewhat so as to form a tubular shaped member. After being received on the mandrel 601, the tape 600 passes through or adjacent an induction heating coil 603. The heating coil 603 transfers energy to the conductive fibres in the tape, which then produce heat. The heat sufficient to cure the polymer, and the tape 600 will consolidate into a unitary piece of tube. In this example the consolidated layer forms an innermost (smoothbore) liner of a pipe body.

In a variation to the above-described embodiment, a polymer tape may be used that is absent of carbon fibres or other conductive filaments. The tape may therefore be formed from substantially 100% polymer or non-conducting material. The polymer tape is applied to a metal (steel) carcass layer, for example. The carcass layer is rotated at a constant speed to receive the tape. After being received on the carcass layer, the tape passes through or adjacent an induction heating coil. The heating coil transfers energy to the metal carcass layer, which then generates heat. The heat from the carcass layer is sufficient to cure the adjacent polymer tape layer, and the polymer tape will consolidate into a unitary piece of tube. In this example the consolidated polymer layer forms a barrier layer of a pipe body.

In a further variation, metal materials could be specifically positioned along the length of a pipe body adjacent or within a particular layer, so as to provide “hot spots” for curing a polymer at those specific locations. It will be appreciated that the metal layer need not be the carcass layer but could be any conductive layer of the pipe body.

In a further variation to the embodiment described above, a first polymer tape, such as polyethylene, that is absent of carbon fibres or other conductive filaments, is applied to a mandrel or carcass layer that rotates at a constant speed to receive the tape. In addition, a further tape including conductive elements, e.g. polyethylene with carbon fibres, is wound over the first tape. As the tapes are induction heated, the two tapes are cured and bonded to form a single layer. The formed layer will be useable as a fluid retaining layer, and have enhanced collapse resistance and pressure resistance. Such a layer may be used to replace some or all of a carcass layer, barrier layer and pressure armour layer.

In the curing of polymers there are various known problems such as residual strain within a material from the forming process and from the temperatures involved, which may affect performance and may lead to physical defects such as crazing. In addition to the even and controllable heating method described above, it may also be useful to have good control over the cooling rate of the polymer. Generally a slow cooling rate will be preferable to a faster cooling rate. As such, the pipe body may be taken through a sequence of induction heaters providing sequentially decreasing levels of heat, for example. Alternatively, a polymer layer may be reheated to a certain temperature using induction heating and then allowed to cool at its most preferable cooling rate.

The invention described above provides accurate, controllable and even heating and curing of polymer layers. The formed layer will also benefit in terms of reduced or eliminated residual stress, thus enhancing performance of the layer and overall pipe structure.

Whilst the above-described methods include a tape being applied to a rotating mandrel, it is also feasible to use a stationary mandrel and wrap the tape by moving the tape itself.

Whilst a thermoplastic polymer has been described, the pipe layer could equally be formed from a thermosetting polymer, such as epoxy resin for example, in a similar manner. The method of the invention could be used to cross-link polymers such as PEX.

The cross-sectional shape of the tape layer could be any shape to suit the application, such as rectangular, oval, round, etc, or formed of two or more corresponding pieces.

The flexible pipe body may alternatively be built up completely, prior to the whole pipe body being induction heated to cure the polymer layers.

It will be clear to a person skilled in the art that features described in relation to any of the embodiments described above can be applicable interchangeably between the different embodiments. The embodiments described above are examples to illustrate various features of the invention.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A method of producing a flexible pipe body, comprising:
providing a length of composite material of thermoplastic or thermosetting material with an electrically conductive material dispersed therein;
applying the length to a mandrel or a layer of flexible pipe body; and
heating the length by induction heating to cure the thermoplastic or thermosetting material.

2. A method as claimed in claim 1, wherein the heating step is performed prior to the applying step.

3. A method as claimed in claim 2 further comprising providing a plurality of lengths of composite material of thermoplastic or thermosetting material with an electrically conductive material dispersed therein, and stacking the plurality of lengths to form the said length, prior to the applying and heating steps.

4. A method as claimed in claim 1 wherein the applying step is performed prior to the heating step.

5. A method as claimed in claim 4 wherein the length is applied to a metal layer of flexible pipe body.

6. A method as claimed in claim 1 wherein the applying step comprises helically wrapping the length onto a mandrel or a layer of flexible pipe.

7. A method as claimed in claim 1 wherein the composite material comprises a matrix material and a plurality of electrically conductive fibres.

8. A method as claimed in claim 7 wherein the plurality of electrically conductive fibres comprise carbon fibres.

9. A method as claimed in claim 8 wherein the carbon fibres comprise carbon nanotubes.

10. A method as claimed in claim 1 wherein the composite material comprises PVDF.

11. A flexible pipe body, comprising:
a layer of composite material of thermoplastic or thermosetting material with an electrically conductive material dispersed therein,
wherein the layer is formed by applying the composite material to a mandrel or a further layer of flexible pipe body and heating the composite material by induction heating to cure the thermoplastic or thermosetting material.

12. A flexible pipe body as claimed in claim 11, wherein the composite material comprises a matrix material and a plurality of electrically conductive fibres.

13. A flexible pipe body as claimed in claim 11 wherein the plurality of electrically conductive fibres comprise carbon fibres.

14. A flexible pipe body as claimed in claim 13 wherein the carbon fibres comprise carbon nanotubes.

15. A flexible pipe body as claimed in claim 11 wherein the composite material comprises PVDF.

16. (canceled)

17. (canceled)
